(19) United States
(12) Patent Application Publication
(10) Pub. No.: US 2011/0076507 A1
(43) Pub. Date: Mar. 31, 2011

(54) GAS BARRIER PACKAGING BOARD

(75) Inventors: Dwayne M. Shearer, Seattle, WA (US); George M. Fox, Longview, WA (US)

(73) Assignee: Weyerhaeuser NR Company, Federal Way, WA (US)

(21) Appl. No.: 12/570,598

(22) Filed: Sep. 30, 2009

(51) Int. Cl. B32B 27/32

(52) U.S. Cl. 428/475.5

(57) ABSTRACT

A paperboard structure having a three layer product side construction of a gas barrier layer comprising a blend of a semi-aromatic semi-crystalline nylon and amorphous nylon, a tie layer and a low density polyethylene layer.

The field is packaging board. More specifically it is a packaging board that may be formed into cartons and cups and has gas barrier properties.

In paperboard containers, a flat paperboard blank is folded over on itself to form a container that is square or rectangular in cross-section. The side ends of the container are sealed together to form the final structure. The paperboard is coated on its exterior and interior surfaces with a heat-sealable material that will bond to form the container. Typically this heat sealable material is a low density polyethylene or other material having a melting point low enough to seal without damaging the paperboard.

There are additional layers of material on the product side of the paperboard, between the paperboard and the interior sealing layer. One of these layers is usually a gas barrier layer.

The need for a gas barrier in paperboard packages is well known and there have been many solutions to reduce gas transfer through the paperboard. The amount and rate of gas transfer will depend on the type of barrier layer or layers that is used. The gas barrier layer is either laminated, extruded or co-extruded onto the paperboard to provide a board with gas barrier properties.

There are other factors than oxygen permeability that enter into the choice of a barrier material. Cost is a factor, both in the type and cost of the barrier material being used and also in the amount required to obtain the necessary barrier properties. The number of layers or laminations of material are a factor in the cost.

Another factor is the adhesion of the material to the paperboard. Some materials adhere better than others. Some materials, such as nylon, require special board surface treatment to obtain adhesion to the paperboard. Often additional layers are used to adhere the barrier layer to the paperboard. This also is reflected in the cost.

Another factor is the heat of the die used to place the material on the paperboard. Often the heat of the die will char the gas barrier layer or the barrier layer will stick to the die, causing shut-downs while the die is cleaned. In some cases an additional layer of material will be used to separate the gas barrier layer from the die lip.

One well known oxygen barrier material is the semi-aromatic nylon MXD6, a condensation polymer of meta-xylylene diamine and adipic acid. MXD6 is a semi-crystalline nylon. Unfortunately, MXD6 does stick to the extrusion die lip where accumulated MXD6 eventually chars.

Another factor is the adhesion of the material to the paperboard. Some materials adhere better than others. Some materials, such as some nylons, require special board surface treatment to obtain adhesion to the paperboard. This also is reflected in the cost. The amorphous nylons, well known oxygen barrier materials have poor adhesion to paperboard.

Extrusion or co-extrusion is a faster, lower cost process than lamination. The cost of a laminate film and associated handling is also avoided with co-extrusion.

Nylons usually require an adhesive or tie layer to adhere the nylon layer to the inner sealing layer.

It would be advantageous to have a gas barrier structure which would be cost effective by reducing the number of laminations, by providing a gas barrier material that would adhere to the paperboard without special treatment and would not char or stick to the extrusion die.

The present invention is directed to a cost effective gas barrier structure which has three layers of material on the product side of the paperboard and uses a blend of nylon MXD6 and amorphous nylon as the gas barrier.

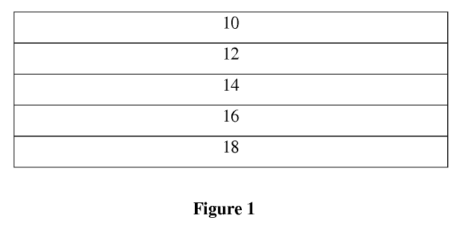

FIG. 1 is a cross-sectional view of the board.

The base material is a paperboard 12 which has a first side and a second side opposite the first side. The first side is the exterior side of the paperboard when it is made into a container. The second side is the interior or product side of the paperboard when it is made into a container. The paperboard may have a weight of 200 to 500 g/m².

A polyolefin layer 10 is applied to the exterior or first surface of the paperboard 12. A typical outer polyolefin layer 10 is low density polyethylene. Layer 10 provides a good print surface. If improved carton durability is required then linear low density polyethylene, metallocene catalyzed linear low density polyethylene or a blend of low density polyethylene and linear low density polyethylene or metallocene catalyzed linear low density polyethylene may be used. These resins are tougher than low density polyethylene resins. Layer 10 is applied in amounts ranging from 14 to 25 grams per square meter (g/m²).

The gas barrier layer 14 has a first side that is applied directly to the inner or second side of paperboard 12. There are no additional layers of material between the gas barrier layer and the paperboard. The gas barrier layer 14 has a second side opposite the first side.

The gas barrier layer 14 is a blend of nylon MXD6 and an amorphous nylon

Nylon MXD6 is a semi-aromatic nylon having a benzene ring in the nylon chain. Nylon MXD6 is a polyamide resin represented by the formula

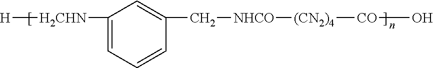

in which n is from 10 to 10,000.

One amorphous nylon is commercially available from DuPont Company of Wilmington Del. under the trademarked designation Selar 3426. Grivory G21 is a similar resin available from EMS. Other amorphous nylons may also be used.

The Selar amorphous nylon copolymers are nylon 6I/6T which is a hexamethyleneisophthalamide-hexamethylene terephthalamide copolymer. Selar 3426 is a hexamethyleneisothalamide-hexamethylene terephathalamide copolymer which has from about 65 percent to about 80 percent of its polymer units derived from hexamethyleneisophthalamide. It is characterized by DuPont Company as being an amorphous nylon (polyamide) having superior transparency, good barrier properties to gases such as O₂, solvents and essential oils and also the following properties according to the indicated standards: density of 1.19 gm/cc (ASTM D1505); glass transition temperature of 127° C. (ASTM D3418); heat deflection temperature of 126° C. at 4.6 Kg/cm² (66 psi) and 123° C. at 18.4 Kg/cm² (264 psi) (ASTM D648); and flexural modulus of 27,900 Kg/cm² (400,000 psi) at 50 percent relative humidity and 23° C. (ASTM D790).

The amorphous nylon copolymer used in the present invention may be manufactured by the condensation of hexamethylenediamine, terephthalic acid, and isophthalic acid according to known processes. It is preferred that a nylon 6I/6T resin be used which is manufactured such that 65 to 80 percent of the polymer units are derived from hexamethylene isophthalamide. Such resins have been approved for food contact use and have a specific gravity of 1.207±0.1, and no melting point.

In one embodiment the amount of MXD6 in the copolymer may range from 50 to 85 weight % and the remainder of the copolymer is nylon 6I/6T. In another embodiment the amount of MXD6 is 70 to 80 weight percent and the remainder is nylon 6I/6T. In another embodiment the amount of MXD6 is 75 weight percent and the remainder is nylon 6I/6T.

This copolymer provides a resin that does not stick to the die head as MXD6 by itself will and also provides a resin that will adhere to the paperboard in distinction to the nylon 6I/6T which will not adhere to the paperboard. This provides a resin which does not require an additional layer to protect it from the die head or to adhere it to the paperboard.

A copolymer that may be used in place of MXD6 is MXD6/MXDI. MXD6/MXDI is a copolymer of MXD6 and methylxylene diisocyanate. It may be used in place of MXD6 in the same amounts as noted above.

A tie layer 16 has one side applied directly to the gas barrier layer 14 without additional layers of material between the gas barrier layer and the tie layer. The tie layer has a first side and a second side opposite the first side. The first side of the tie layer 16 is applied directly to the interior or second side of gas barrier layer 14. The tie layer 16 may be any appropriate adhesive resin. A typical adhesive resin is a maleic anhydride modified polyethylene resin. Bynel® 4288 may be used as a tie layer. The adhesive resin may be a modified ethylene vinyl acetate, a modified ethylene acrylate, an anhydride modified high-density polyethylene, an anhydride modified linear low density polyethylene, an anhydride modified low density polyethylene or an anhydride modified polypropylene. Surlyn® may be used as a tie layer. Surlyn® is a partial sodium or magnesium salt of an ethylene/methacrylic acid copolymer. The usual amount of tie resin would be 3 to 9 grams per square meter.

An inner polyolefin layer 18 has ones side applied directly to the tie layer 16 without any additional layers of material between the inner polyolefin layer and the tie layer. The inner polyolefin layer has a first side and a second side. The first side of the polyolefin layer 18 is applied directly to the second side of tie layer 16. The inner polyolefin product contact layer 18 is low density polyethylene. The amount of polyethylene may range from 10 to 40 grams per square meter.

In one embodiment the gas barrier layer, the tie layer and the polyethylene layer are co-extruded.

This construction provides a three layer product side gas barrier layer and sealing layer construction.

Although preferred embodiments of the invention have been described using specific terms, such description is for illustrative purposes only. The words used are words of description rather than of limitation. It is to be understood that changes and variations may be made by those of ordinary skill in the art without departing from the spirit or scope of the present invention, which is set forth in the following claims. The spirit and scope of the appended claims should not be limited to the description of the preferred versions contained herein.

1. A paperboard with gas barrier properties consisting of paperboard,
a three layer interior construction applied to the paperboard,
a gas barrier layer applied directly to the paperboard, the gas barrier consisting of a blend of semi-aromatic semi-crystalline nylon and amorphous nylon,
a tie layer applied directly to the gas barrier layer, and
a low density polyethylene applied directly to the tie layer.

2. The paperboard of claim 1 wherein the semi-aromatic semi-crystalline nylon is 50 to 85 weight percent of the blend of semi-aromatic semi-crystalline nylon and amorphous nylon.

3. The paperboard of claim 2 wherein the semi-aromatic semi-crystalline nylon is 70 to 80 weight percent of the blend of semi-aromatic semi-crystalline nylon and amorphous nylon.

4. The paperboard of claim 2 wherein the semi-aromatic semi-crystalline nylon is 75 weight percent of the blend of semi-aromatic semi-crystalline nylon and amorphous nylon.

5. The paperboard of claim 1 wherein the semi-aromatic semi-crystalline nylon is nylon MXD6

6. The paperboard of claim 5 wherein the semi-aromatic semi-crystalline nylon is 50 to 85 weight percent of the blend of semi-aromatic semi-crystalline nylon and amorphous nylon.

7. The paperboard of claim 5 wherein the semi-aromatic semi-crystalline nylon is 70 to 80 weight percent of the blend of semi-aromatic semi-crystalline nylon and amorphous nylon.

8. The paperboard of claim 5 wherein the semi-aromatic semi-crystalline nylon is 75 weight percent of the blend of semi-aromatic semi-crystalline nylon and amorphous nylon.

9. The paperboard of claim 8 wherein the amorphous nylon is nylon 6I/6T

10. The paperboard of claim 7 wherein the amorphous nylon is nylon 6I/6T

11. The paperboard of claim 6 wherein the amorphous nylon is nylon 6I/6T

12. The paperboard of claim 5 wherein the amorphous nylon is nylon 6I/6T

13. The paperboard of claim 1 wherein the gas barrier layer, the tie layer and the polyolefin layer are co-extruded.

14. The paperboard of claim 1 further comprising a second layer of polyolefin applied directly to the side of the paperboard opposite the gas barrier layer.

15. The paperboard of claim 1 wherein the semi-aromatic semi-crystalline nylon is a copolymer of nylon MXD6 and MXDI.

16. The paperboard of claim 15 wherein the semi-aromatic semi-crystalline nylon is 50 to 85 weight percent of the blend of semi-aromatic nylon and amorphous nylon.

17. The paperboard of claim 15 wherein the semi-aromatic semi-crystalline nylon is 70 to 80 weight percent of the blend of semi-aromatic semi-crystalline nylon and amorphous nylon.

18. The paperboard of claim 15 wherein the semi-aromatic semi-crystalline nylon is 75 weight percent of the blend of semi-aromatic semi-crystalline nylon and amorphous nylon.

19. The paperboard of claim 15 wherein the amorphous nylon is nylon 6I/6T
